(19) United States
(12) Patent Application Publication
(10) Pub. No.: US 2026/0312883 A1
(43) Pub. Date: Oct. 8, 2026

(54) METHOD AND APPARATUS FOR ARTIFICIAL INTELLIGENCE (AI) MODEL IDENTIFICATION

(71) Applicant: Samsung Electronics Co., Ltd., Suwon-si, Gyeonggi-do (KR)

(72) Inventors: Chadi KHIRALLAH, Staines (GB); Mythri HUNUKUMBURE, Staines (GB); Oluwatayo Yetunde KOLAWOLE, Staines (GB)

(21) Appl. No.: 19/482,622

(22) PCT Filed: May 10, 2024
(86) PCT No.: PCT/KR2024/006389

§ 371 Date: Nov. 7, 2025

(30) Foreign Application Priority Data
May 12, 2023 (GB) 2307139.2
Apr. 2, 2024 (GB) 2404703.7

(51) Int. Cl. H04L 41/16

(52) U.S. Cl. CPC H04L 41/16

(57) ABSTRACT

The disclosure relates to a 5G or 6G communication system for supporting a higher data transmission rate. A method for AI/ML management in a wireless communications system comprising a UE and a network, the method comprising: receiving, at the UE from the network, information for identifying an AI/ML model or an AI/ML functionality; identifying, by the UE, at least one AI/ML model or AI/ML functionality based on the received information; performing, by the UE, an operation based on the identified at least one AI/ML model or AI/ML functionality, wherein the information for identifying an AI/ML model or an AI/ML functionality includes an ID associated with the AI/ML model or AI/ML functionality and meta data associated with the AI/ML model or AI/ML functionality.

### TECHNICAL FIELD

Various embodiments of the disclosure provide approaches for the use of Artificial Intelligence/Machine Learning (AI/ML) model identification for model description.

For example, certain examples of the disclosure provide methods, apparatus and systems for the use of Artificial Intelligence/Machine Learning (AI/ML) model identification for model description in 3rd Generation Partnership Project (3GPP) networks such as 5th Generation (5G) and/or 6th Generation (6G) networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) and Fifth Generation (5G) systems are now widely deployed, and development of Sixth Generation (6G) Systems is in progress.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. New frameworks and architectures are also being developed for 6th Generation (6G) networks.

### DISCLOSURE OF INVENTION

### Solution to Problem

It is an aim of various embodiments of the disclosure to address, solve and/or mitigate, at least partly, at least one of the problems and/or disadvantages associated with the related art, for example at least one of the problems and/or disadvantages described herein. It is an aim of various embodiments of the disclosure to provide at least one advantage over the related art, for example at least one of the advantages described herein.

In particular, the disclosure provides a development of AI/ML model IDs to also carry meta data about the models. This will be useful to implement in 3GPP now, before the number of AI/ML models in RAN starts to grow exponentially. The AI/ML model ID can be formulated to reflect certain properties of the model and/or certain relationships one model has with other models. By using the AI/ML model ID to carry such meta data, it will be easier for the network to identify model properties and links amongst each other models, without resorting to using a model catalogue, which will consume additional resources.

In accordance with a first aspect of the disclosure, there is provided a method for AI/ML management in a wireless communications system comprising a UE and a network, the method comprising: receiving, at the UE from the network, information for identifying an AI/ML model or an AI/ML functionality; identifying, by the UE, at least one AI/ML model or AI/ML functionality based on the received information; performing, by the UE, an operation based on the identified at least one AI/ML model or AI/ML functionality, wherein the information for identifying an AI/ML model or an AI/ML functionality includes an ID associated with the AI/ML model or AI/ML functionality and meta data associated with the AI/ML model or AI/ML functionality.

In accordance with an example of the disclosure, the operation includes reporting, by the UE to the network, information on the identified at least one AI/ML model or AI/ML functionality.

In accordance with an example of the disclosure, the operation includes one or more of activating, deactivating, selecting, and/or switching the identified at least one AI/ML model or AI/ML functionality.

In accordance with an example of the disclosure, the identifying includes identifying at least one AI/ML model or AI/ML functionality that belongs to a category indicated by the information for identifying an AI/ML model or an AI/ML functionality.

In accordance with an example of the disclosure, the information for identifying an AI/ML model or an AI/ML functionality includes a first functionality and the identifying includes identifying at least one AI/ML model that provides the first functionality.

In accordance with an example of the disclosure, the meta data includes information indicating or associated with one or more of: a category of the AI/ML model or AI/ ML functionality; a similar AI/ML model or AI/ML functionality; a linked AI/ML model or AI/ML functionality; a feature of the AI/ML model or AI/ML functionality; a dataset associated with the AI/ML model or AI/ML functionality; a type of the AI/ML model or AI/ML functionality; an accuracy of the AI/ML model or AI/ML functionality; a reliability of the AI/ML model or AI/ML functionality; an age of the AI/ML model or AI/ML functionality; an expiry of the AI/ML model or AI/ ML functionality; a security of the AI/ML model or AI/ML functionality; and an applicability of the AI/ML model or AI/ML functionality.

In accordance with an example of the disclosure, the ID and meta data are included in one or more fields or headers appended to or included in a model ID data structure.

In accordance with an example of the disclosure, the operation includes updating the ID and/or meta data associated with the AI/ML model or AI/ML functionality.

In accordance with an example of the disclosure, the method further includes, receiving at the UE from the network, information configuring the mapping of the information for identifying an AI/ML model or an AI/ML functionality.

In accordance with an example of the disclosure, the operation includes configuring, triggering, and/or performing data collection for the identified at least one AI/ML model or AI/ML functionality.

In accordance with an example of the disclosure, the information for identifying an AI/ML model or an AI/ML functionality is received from a radio access network (RAN) of the wireless communications system, a network data analytics function (NWDAF) of the wireless communications systems, and/or a core network of the wireless communications system.

In accordance with an example of the disclosure, the operation includes determining whether the identified at least one AI/ML model or an AI/ML functionality can be trained using similar data sets.

In accordance with an example of the disclosure, the method further comprises updating by the network an ID and/or meta data associated with an AI/ML model or AI/ML functionality and providing an indication of the updated ID and/or meta data to the UE.

In accordance with an example of the disclosure, the AI/ML models and AI/ML functionalities are network-side, UE-side, and/or two-sided models/functionalities.

In accordance with an example of the disclosure, the wireless communications system is a 3GPP compliant wireless communications system.

In accordance with a second aspect of the disclosure, there is provided a wireless communications system comprising a UE and a network, wherein the wireless communications system is configured to implement the first aspect of the disclosure and any of the associated examples.

In accordance with a third aspect of the disclosure, there is provided a method for a user equipment in a wireless communications system comprising the UE and a network, the method comprising: receiving, from the network, information for identifying an AI/ML model or an AI/ML functionality; identifying at least one AI/ ML model or AI/ML functionality based on the received information; performing an operation based on the identified at least one AI/ML model or AI/ML functionality, wherein the information for identifying an AI/ML model or an AI/ML functionality includes an ID associated with the AI/ML model or AI/ML functionality and meta data associated with the AI/ML model or AI/ML functionality.

In accordance with a fourth aspect of the disclosure, there is provided a user equipment (UE) for use in a wireless communication system comprises the UE and a network, wherein the UE comprises a transmitter, a receiver, and a processor, and the processor is configured in combination with the transmitter and/or receiver to: receive from the network, information for identifying an AI/ML model or an AI/ML functionality; identify at least one AI/ML model or AI/ML functionality based on the received information; perform an operation based on the identified at least one AI/ ML model or AI/ML functionality, wherein the information for identifying an AI/ML model or an AI/ML functionality includes an ID associated with the AI/ML model or AI/ML functionality and meta data associated with the AI/ML model or AI/ML functionality. Other aspects, advantages, and salient features of the disclosure will become apparent to those skilled in the art from the following detailed description taken in conjunction with the accompanying drawings.

### Advantageous Effects of Invention

Aspects of the disclosure are to address at least the above-mentioned problems and/ or disadvantages and to provide at least the advantages described below. Accordingly, an aspect of the disclosure is to provide efficient communication methods in a wireless communication system.

### BRIEF DESCRIPTION OF DRAWINGS

Embodiments/examples of the disclosure are further described hereinafter with reference to the accompanying drawings, in which:

FIGS. 1A and 1B provide example configurations of an AI/ML model ID in accordance with the disclosure;

FIG. 2 provides a block diagram of an exemplary network entity/function that may be used in various embodiments of the disclosure; and

FIG. 3 provides a flow diagram of an example method for AI/ML management in a wireless communications system in accordance with the disclosure.

FIG. 4 illustrates a structure of a network entity according to the various embodiments disclosed herein.

FIG. 5 illustrates a structure of a user equipment according to the various embodiments disclosed herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### Mode for the Invention

The following description of examples of the disclosure, with reference to the accompanying drawings, is provided to assist in a comprehensive understanding of various embodiments of the disclosure. The description includes various specific details to assist in that understanding but these are to be regarded as merely exemplary. Accordingly, those of ordinary skill in the art will recognize that various changes and modifications of the examples described herein can be made without departing from the scope of the disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the disclosure.

The terms and words used herein are not limited to the bibliographical or standard meanings, but are merely used to enable a clear and consistent understanding of the disclosure.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like) and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

The following examples are applicable to, and use terminology associated with, 3GPP 4G (e.g., LTE) and/or 5G (e.g., NR). However, the skilled person will appreciate that the techniques disclosed herein are not limited to these examples or to 3GPP 4G (e.g., LTE) and/or 5G (e.g., NR), and may be applied in any suitable system or standard, for example one or more existing and/or future generation wireless communication systems or standards (e.g., B5G, 5G-Advanced, 6G etc.). The skilled person will appreciate that the techniques disclosed herein may be applied in any existing or future releases of 3GPP 4G (e.g., LTE) and/or 5G (e.g., NR) and/or 5G Advanced and/or 6G, and/or (3GPP Release 17, 18, 19, 20, etc.) or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

Furthermore. the following also applies to the disclosure:
The terms functionality/use-case/configuration/scenario/site may be used interchangeably.
The terms model and model functionality may be used interchangeably.
This disclosure also apply to non-3GPP entities.
The concepts, proposals, solutions, methods, embodiments, figures, and/or examples, presented in this disclosure, would apply to various type of communication systems, such as 4G, 4G-Advanced, 5G, 5G-Advanced, and 6G. Moreover, the above may also apply (in full or part or modified) to systems of Non-Terrestrial Networks (NR-NTN and/or IoT-NTN and/or UAV, etc.), in addition to Terrestrial Networks (TN).

A particular network entity may be implemented as a network element on dedicated hardware, as a software instance running on a dedicated hardware, and/ or as a virtualised function instantiated on an appropriate platform, e.g. on a cloud infrastructure.

The skilled person will appreciate that the disclosure is not limited to the specific examples disclosed herein. For example:
The techniques disclosed herein are not limited to 3GPP 4G or 5G or 5G-Advanced and also apply to B5G and 6G systems.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in various embodiments.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Various embodiments of the disclosure may be provided in the form of an apparatus/ device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Various embodiments of the disclosure may be provided in the form of a system (e.g., a network) comprising one or more such apparatuses/devices/network entities, and/or a method therefor.

Artificial Intelligence (AI)/Machine Learning (ML) in 3GPP Networks

3GPP has also started studying the benefits of introducing Artificial Intelligence (AI)/Machine Learning (ML) solutions to communications networks, for example, enhancement of management and orchestration, performance, resource allocation, in addition to reduction of complexity and overhead in the network [1].

AI/ML for NR Air Interface is currently a study item in 3GPP working groups (WGs) RAN1 and RAN2. Both WGs have discussed the use of model ID in association with different AI/ML life-cycle-management (LCM) purposes and model transfer/delivery. The following is a list of latest agreements in RAN2 on model ID. [2][3]
Model ID can be used to identify model or models for the following LCM purposes: model selection/activation/deactivation/switching (or identification, if that will be supported as a separate step). (e.g. for so called “model ID based LCM”).—If model transfer/delivery is supported, model ID can be used for model transfer/delivery LCM purpose.
How to achieve globality of the Model ID is for further study (FFS). Initial discussion in RAN2: the following global unique model ID definition directions can be considered as a starting point:
Direction1: Pre-defined/hard-coded global unique model ID
Direction3: Assigned global unique model ID via specific ID management node.

Note: Other global unique model ID definition is not precluded. Model ID structure, if any, is FFS.

The following is a list of latest agreements in RAN1 on model ID: [4]

For AI/ML model identification and model-ID-based LCM of UE-side models and/or UE-part of two-sided models:

Model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

FFS: Which aspects should be considered as additional conditions, and how to include them into model description information during model identification will be discussed in each sub-use-case agenda.

However, as shown above, the model ID structure, model description and relation to model identification remain as open points (FFS) that require further study and a suitable solution.

The number of AI/ML models for RAN optimisations is expected to grow rapidly in the next few years. In terms of managing these models in the network, the model ID can play a crucial role, by conveying meta data about the models. Without such meta data in the model ID, it would take additional resources to categorize and manage the vast number of AI/ML models expected in RAN in the near future. In the current RAN2 discussions, the AI/ML model ID is used only to uniquely identify a certain AI/ ML model, which is a limitation on the potential capabilities the model ID can also be used for.

This disclosure provides a detailed derivation for the AI/ML model ID, which can reveal meta data about the AI/ML models, particularly for related or linked AI/ML Models

In particular, the disclosure is centred around the use of a AI/ML model ID to convey meta data about the particular model or a group of similar models. This meta data can include (but not necessarily limited to):
Similar models: models that have (or share in part or all) certain features, properties, functionality, scenarios, use cases, configurations, data sets (e.g. data for training, monitoring, testing, etc), complexity (e.g. number of layers, parameters, other), size and/or other information related to an AI/ML model (or models), can be called ‘similar’ models.
Linked models: models that have (or share in part or all) certain relationships, interactions, collaborations, and/or any other actions related to those models, can be considered as ‘linked’ models.

Details and examples of the above two categories and how the AI/ML model IDs can be developed to showcase such meta data are given below.

Similarly, all solutions, examples, and figures, provided in relation to the AI/ML model ID, may also equally apply (or with some modifications) to the case/concept of AI/ML functionality/functionalities, AI/ML functionality identification (e.g. functionality ID), and/or functionality-based life-cycle-management (LCM) purposes.

### ‘Similar’ AI/ML Models

The AI/ML models can be similar in many number of ways. For example, the following two broad types:
1) AI/ML models may be predicting (inferring) the future patterns of certain RAN parameters and reporting them, without doing any RAN parameter related modifications. For example, an AI/ML model can observe and then infer the power consumption in RAN and provide this as an input to a network management function. This data can be used to plan out and schedule the different power sources to the network (renewable, non-renewable) for example.
2) AI/ML models inferences can be used to directly update or change certain RAN parameter(s). An example would be to observe and then infer the RSRP reported values from a UE of the serving and neighbour cells and this inference to influence the handover preparations for the UE.

The main difference between these two types is that the first one (only) monitors RAN parameters and the second monitors and changes (other) RAN parameters.

Another ‘similarity’ between AI/ML models can be in the fact that they use the same (or similar, or related) input data sets. For example, RSRP/RSRQ data can be used as input to train an AI/ML model to infer the next Modulation and Coding Schemes (MCS) allocations. In a 5G beamforming network, the RSRP/RSRQ from the serving beam and the neighbouring beams can be used in another AI/ML model to facilitate beam switching through inference. The fact that these AI/ML models share the same or similar data sets can be very useful for the network to know early on-so that required resource allocations for data transfer and model transfer/delivery can be optimized, if both these AI/ML models are to be used in the network. The model ID may provide an easier and/or efficient way to convey this meta data.

In one example, the network, network entity, UE (or a group of UEs), server, OAM, operator, and/or application, can assign a given number of bits (or segment or part) of a given model ID (or models IDs) to indicate if an AI/ML model (or models) belong(s) to at least one category. In a related example, one or more models that belong to this category have the same pattern of bits in this segment of the model ID.

In some examples, the model (or models) may belong to more than one category.

In some examples, the network determines (or decides) whether at least one model belongs to at least one model category.

In some examples, the network entity (and/or function) and/or the UE (or a group of UEs) that assigns the model ID (or models IDs) also assigns the model category.

In some examples, the network indicates (or informs or reports) to at least one network entity (and/or function), the desired UE (or a group of UEs), external entity (or function), a server, application, OAM, the model (or a group of models) that belong to at least one model category.

In some examples, the network configures the UE (or a group of UEs) to be able to determine (or decide) whether at least one model belongs to at least one model category.

In some examples, the UE (or a group of UEs) may determine whether at least one model belongs to a given model category.

In some examples, the network and/or the UE may update the model (or models) category (-ies) and inform the other side of this update. In a related example, the entity that updates the category can update the model ID (e.g. segment) accordingly, and inform (or report) the other entity of the change of the model ID.

In some example, the UE indicates (or informs or reports) to at least one network entity (and/or function), the another UE (or a group of other UEs), external entity (or function), a server, application, OAM, that a given model (or models) belong(s) to at least one model category.

In some examples, the UE may send a request to the network asking if a given model (or models) belong(s) (or not belong anymore) to a given model category (or more than one category). In one example, the UE may send the request included in an existing or newly dedicated RRC and/or NAS signalling/messages and/or IEs. In a related example, the network may confirm (or acknowledge) to the UE if the model (or models) belong(s) to the model category, using a an existing or newly dedicated RRC and/or NAS signalling/messages and/or IEs. In an alternative example, the network may indicate to the UE (or group of UEs) that the model (or models) belong to a different category. This information may be also sent to the UE (or group of UEs) in the confirm (or acknowledge) message.

In some examples, the network and the UE (or group of UEs) may use the information included in the segments of the model ID, for example, information related to the data category to determine whether a given model (or models) can be trained using the same (or similar) data sets. For example, the network and/or the UE (or group of UEs) may not need to perform data collection (or acquire data) frequently to train models in the same category, if a model ID indicates that those models use same (or similar) data sets. That is, the UE can simply use the data sets (or slightly modified) to train all models in this category. This may avoid performing frequent data collection procedure for all models.

In another example, the information related to the model category may be included as part of the model meta data.

In another example, some bits in the model ID can convey information that describe the similarity features of those models included in the same category, for example, one bit to indicate if models use a common (or same or similar) input data set(s), one bit to indicate if models have similar complexity, one bit to indicate similar functionality/use case, etc. In a related example, a segment of 3 bits of the model ID, ‘100’, may indicate ‘1={similar data set}, 0={not similar/different complexity}, 0={not similar/different usecase}’.

In one example, the network reports to the desired UE (or a group UEs) the set (or group) of models included in the similar models category. In a related example, the network sends the mapping between models' similarity features and bit order in the model ID (header).

In one example, the network may configure the mapping of a model ID (or bit or segments of the model ID) to models' similarity features, for models stored in the network and/or UE (or group of UEs), using RRC and/or NAS signaling/messages and/ or via system information broadcast (e.g. periodically, or on-demand). For example, the NG-RAN (or gNB) may configure the mapping by using newly defined and/or existing RRC signaling/messages.

In another example, the network may update (or modify) the mapping of a model ID (or bit or segments of the model ID) to models' similarity features, for models stored in the network and/or UE (or group of UEs), using RRC and/or NAS signaling/messages messages and/or via system information broadcast (e.g. periodically, or on-demand). For example, the NG-RAN (or gNB) may update the mapping by using newly defined and/or existing RRC signaling/messages.

In another example, the UE (or group of UEs) may map (or update an existing mapping) of model ID (bit or segments) to models' similarity features, for example, for models stored in the UE (or group of UEs). Additionally, the UE (or group of UEs) may inform the network of the mapping (or updated mapping) using RRC and/or NAS signaling/messages.

In another example, the network and/or the UE may share information related to their capability to support the mapping of models' similarity features to a model ID. In an alternative example, the network and/or the UE may share information related to their capability to support model ID segmentation and/or mapping to indicate a set of models with similar features.

In one example, the network may use the information in the model ID, and/or any other information related to the model (or models) that belong(s) to a given category, to select and/or activate at least one model at the network-side, UE-side, and/or two-sided models, using the models category identification. In various embodiments, the network may activate at least one model (or model part), at the UE (e.g. UE-side, or UE-part of two-sided models) using one indication (or report) message (or flag or bit in a message).

In another example, the network may use the information in the model ID, and/ or any other information related to the model (or models) that belong(s) to a given category, to deactivate at least one model at the network-side, UE-side, and/or two-sided models, using the models' category identification. In certain example, the network may deactivate at least one model (or model part), at the UE (e.g. UE-side, or UE-part of two-sided models), using one indication (or report) message (or flag or bit in a message).

In an example, the information related to the model (or models) category (or categories), model ID (or models IDs), or model meta data, and/or any other information (or data) related to the model (or models) and/or model operation (e.g. LCM procedures), may be exchanged with at least one network entity (and/or function). A certain example would be that the information may be exchanged with the NWDAF, and/or NWDAF and CN, and/or NWDAF and the UE (or a group of UEs), and/or NWDAF and the NG-RAN, and/or a mix of or all the previous entities.

In another example, the network and/or UE (or a group of UEs) may trigger data collection for a set (or group) of models that share, belong to, and/or have similar data sets for a given LCM purpose.

### ‘Linked’ AI/ML Models

In this type, AI/ML models can be ‘linked’ such that the output(s) from one model can provide (one or more of the) inputs to another AI/ML model. One example is the RSRP/RSRQ input based MCS allocation model previously mentioned. This is linked to a model which optimizes the HARQ re-transmissions, taking RSRP/RSRQ values and any errors in MCS allocations as inputs. In this case, if both models are operating, the performance HARQ re-transmission model (A) will be influenced by the performance of the MCS allocation model (B). If B is operating optimally in terms of reducing errors, there will be very little or no corrective work that the model A has to perform. In another scenario, an operator may choose to ultilize both models so as to optimize the data throughput. In this case, model B will allocate MCS more aggressively, relying on model A to correct any errors through re-transmissions. Likewise, there are many implications and usages of linked AI/ML models and the network will benefit from knowing these relationships through the model ID meta data.

In one example, the model IDs can be configured to show the ‘links’ between or amongst 2 or more such AI/ML models. As in the above example, the models can be categorized as ‘parent’ or ‘child’ models and this can be reflected by a few bits (or segment or part) in the model ID.

In another example, information such as the level of dependency between models and how many network approved models are present in this ‘link’ can also be conveyed by few bits (or segment or part) in the model ID.

In one example, the network may select and/or activate a set (or group) of linked models at the network-side, UE-side, and/or two-sided models, using the information in the models' category identification.

In another example, the network may deactivate a set (or group) of linked models at the network-side, UE-side, and/or two-sided models, using the information in the models' category identification.

In another example, the network and/or UE (or a group of UEs) may trigger data collection for a set (or group) of linked models that share, belong to, and/or have similar data sets for a given LCM purpose.

In another example, the information related to the model (or models) category (or categories), model ID (or models IDs), or model meta data, and/or any other information (or data) related to the model (or models) and/or model operation (e.g. LCM procedures), may be exchanged with at least one network entity (and/or function). A certain example would be that the information may be exchanged with the NWDAF, and/or NWDAF and CN, and/or NWDAF and the UE (or a group of UEs), and/or NWDAF and the NG-RAN, and/or a mix or all the previous entities.

### Configuration of the AI/ML Model ID

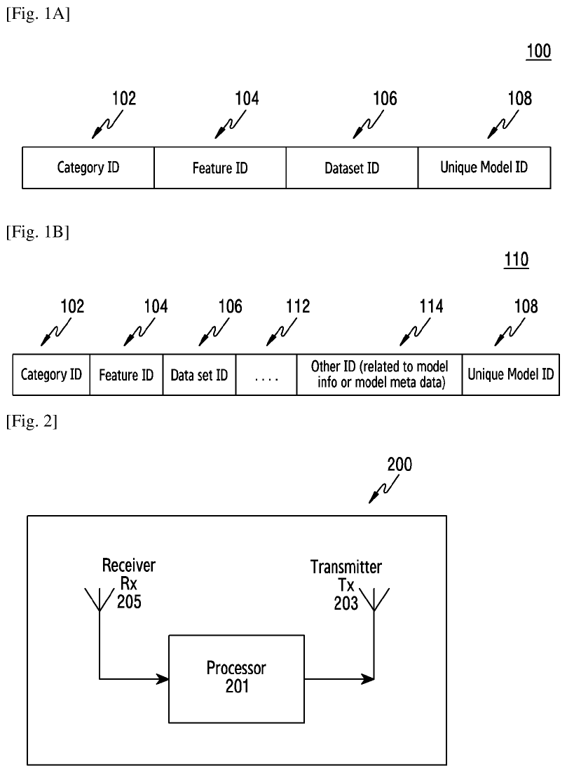

The model ID can be configured to include header(s) which indicate the features and attributes as discussed above. An example model ID configuration would be to concatenate these headers (e.g. Category ID 102, Feature ID 104, Dataset ID 106) in front of the unique model ID part (e.g. 108), which is unique to the particular AI/ML model. Such an example model ID 100 is depicted in the FIG. 1A.

It should be stressed that this is only an example configuration—there can be many variations in arrangement of these headers and even splitting up of these headers into sub-fields. For example, the model ID may have only some of the headers/fields shown in FIG. 1A and/or described above, and/or may include additional headers. The basic idea of appending the unique model ID with identifiable headers/fields related to some form of meta data is the key aspect of this example configuration.

FIG. 1B provides another more general example of a model ID 110, which includes an “other ID” 114 to reflect any other type of common meta data that could be identified in a similar way to that described above. Further types of data may or may not be present in the model ID, as illustrated by the optional presence of 112. The sizes of the various fields in FIGS. 1A and 1B are for illustration purposes only and they may take any suitable bit-size. As for FIG. 1A, the model ID of FIG. 1B may have only some of the headers/fields shown and/or described above.

Although AI/ML models have mainly be discussed with respect to their use in the RAN, it should be noted that the use of the models in the RAN is merely an example and they may be applied to any suitable part of the network and network entities thereof. For example, the network may run AI/ML models from 3^{rd} party clients and provide some outputs to these clients (e.g. location data). Here again, the AI/ML model IDs can be used to indicate meta data about the models. This way the model management becomes easier for the network, as in these RAN examples provided above.

Further examples in accordance with the disclosure are set out below, where the examples may be combined in any appropriate form and also combined with any of the approaches set out above.

In accordance with an example of the disclosure, there is provided an AI/ML model ID data format/structure that includes an indication of one of more types of meta data/or meta data itself in addition to a unique model ID. The types of meta data may include, but not limited to, one or more of including a category ID, a feature ID, and a dataset ID. In other words, the model ID may include information that provides or indicates a further description of the model.

The indication/meta data may be included in one or more headers or fields appended to or included in an enlarged model ID.

The category ID may indicate a predetermined category that a model is a member of or related to. The category types may take any suitable form, for example, models that predict behaviours and models that control behaviours.

The feature ID may indicate one or more features of the model and/or one or more features that are similar/common to other models and/or other models in the same category.

The dataset ID may indicate one or more datasets used by the model and/or datasets that are similar/common to other models and/or other models in the same category.

Information indicated by one or more of the category ID, feature ID, dataset ID or other meta data may include, but are not limited to, one or more of a model type, model complexity, model accuracy, model reliability, model dataset type, model age, model expiry, model security, model applicability, and model features.

In some examples, the model ID may include further headers/fields, such as a field explicitly indicating related models, using their unique model ID for instance.

The model ID may be configured when the model is first generated or configured.

The model ID may also be updated if required, for example, due to new datasets, new models, or additional features being included in the model.

Model IDs may be distributed to any suitable network entity by any other suitable network entity, for example, any network entity that is required to provide or be provided with information on AI/ML models. For example, a gNB may transmit a model ID, a category ID or any other meta data indication to a UE. Alternatively, a AI/ ML related network entity may transmit a model ID, a category ID or any other meta data indication to another network entity that requires or has requested information on AI/ML models.

The meta data of the model ID may also be leveraged to indicate one or more models without indicating individual unique model IDs, thus providing a more efficient way of communicating data concerning AI/ML models throughout a network.

In some examples, via the use of the meta data of the model ID, a network entity may be able to quickly and easily identify or indicate models that correspond to a request from another network entity, for example, models that utilise similar data sets and/or offer similar predictive or control functions.

It will be appreciated that examples of the disclosure may be realized in the form of hardware, software or a combination of hardware and software. Various embodiments of the disclosure may provide a computer program comprising instructions or code which, when executed, implement a method, system and/or apparatus in accordance with any aspect, example and/or embodiment disclosed herein. Certain embodiments of the disclosure provide a machine-readable storage storing such a program.

FIG. 2 is a block diagram of an exemplary network entity/function that may be used in examples of the disclosure, such as the techniques disclosed in relation to any of the figures. For example, any of the network entities, network function etc. may be provided in the form of the network entity illustrated in FIG. 2. The skilled person will appreciate that a network entity/function may be implemented, for example, as a network element on a dedicated hardware, as a software instance running on a dedicated hardware, and/or as a virtualised function instantiated on an appropriate platform, e.g. on a cloud infrastructure.

The entity 200 comprises a processor (or controller) 201, a transmitter 203 and a receiver 205. The receiver 205 is configured for receiving one or more messages from one or more other network entities, for example as described above. The transmitter 203 is configured for transmitting one or more messages to one or more other network entities, for example as described above. The processor 201 is configured for performing one or more operations, for example according to the operations as described above.

For example, entity 200 may configure, update, generate, transmit, and/or receive the example model IDs described above or elements thereof. The entity may also be use the above-described model ID to identify and/or use AI/ML models suitable for a particular function.

FIG. 3 provides a flow diagram of an example method for AI/ML management in a wireless communications system that utilises examples of the model ID described above, where the wireless communications system includes but is not limited to a UE and a network (e.g. one or more network entities) for communicating with the UE.

At step S302, the UE receives, from the network, information for identifying an AI/ML model or an AI/ML functionality. The information for identifying an AI/ML model or an AI/ML functionality may include any of the data/information described above as being part of the model ID e.g. unique IDs, meta data etc.

At step S304, the UE identifies at least one AI/ML model or AI/ML functionality based on the received information. For example, if the information for identifying an AI/ML model or an AI/ML functionality includes a category of an AI/ML model or AI/ML functionality, the UE may identify AI/ML models and/or AI/ML functionalities that belong to the category.

At step S306, the UE performs an operation based on the identified at least one AI/ ML model or AI/ML functionality. For example, the UE may report to the network information on the identified at least one AI/ML model or AI/ML functionality, the UE may activate, deactivate, select, and/or switch the identified at least one AI/ML model or AI/ML functionality, or the UE may configure, trigger, and/or perform data collection for the identified at least one AI/ML model or AI/ML functionality.

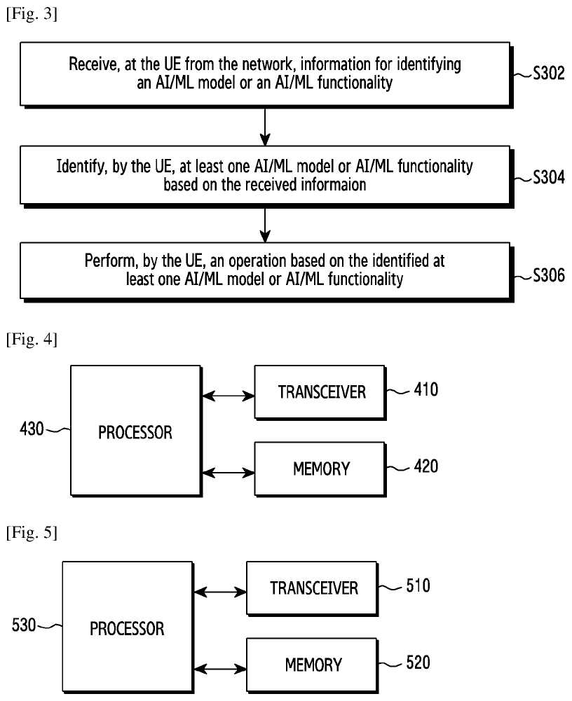

FIG. 4 illustrates a structure of a network entity, according to various embodiments as disclosed herein.

Referring to FIG. 4, the network entity includes a transceiver (410), a memory (420), and a processor (430). The transceiver (410), the memory (420), and the processor (430) of the network entity may operate according to a communication method of the network entity described above. However, the components of the network entity are not limited thereto. For example, the network entity may include fewer or a greater number of components than those described above. In addition, the processor (430), the transceiver (410), and the memory (420) may be implemented as a single chip. Also, the processor (430) may include at least one processor.

The network entity includes at least one entity of a core network. For example, the network entity includes an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto. For example, the network entity may correspond to a network function of FIG. 2.

The transceiver (410) collectively refers to a network entity receiver and a network entity transmitter, and may transmit/receive a signal to/from a base station or a UE. The signal transmitted or received to or from the base station or the UE may include control information and data. In this regard, the transceiver (410) may include an RF transmitter for up-converting and amplifying a frequency of a transmitted signal, and an RF receiver for amplifying low-noise and down-converting a frequency of a received signal. However, this is only an example of the transceiver (410) and components of the transceiver (410) are not limited to the RF transmitter and the RF receiver.

The transceiver (410) may receive and output, to the processor (430), a signal through a wireless channel, and transmit a signal output from the processor (430) through the wireless channel.

The memory (420) may store a program and data required for operations of the network entity. Also, the memory (420) may store control information or data included in a signal obtained by the network entity. The memory (420) may be a storage medium, such as a ROM, a RAM, a hard disk, a CD-ROM, and a DVD, or a combination of storage media.

The processor (430) may control a series of processes such that the network entity operates as described above. For example, the transceiver (410) may receive a data signal including a control signal, and the processor (430) may determine a result of receiving the data signal.

FIG. 5 illustrates a structure of a user equipment (UE) according to the various embodiments disclosed herein.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE.

Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another.

The storage medium may be any available medium that can be accessed by a general purpose or special purpose computer.

For all of the examples/aspects/embodiments etc. described above/herein, it should be considered that the corresponding features/operations apply in any order or combination, and that furthermore there exists the possibility to omit one or more features/operations.

Moreover, for all of the examples, embodiments, aspects etc. above, these apply to at least LTE, NR, NR NTN or IoT NTN (note this list is merely to give some examples and should not be seen as limiting), including any related signalling/messages on any of the inferences X2, Xn, NG, S1, F1, etc (again, this list is merely to give some examples and should not be seen as limiting). It will be appreciated that, in each example/embodiment/aspect etc. described above, one or more features or operations may be omitted, modified or moved (e.g., to change the order of the features or the operations), if desired and appropriate.

Additionally, where the figures illustrating example method flows include text in relation to a specific step/operation, it will be appreciated that this text is simply an example of the corresponding step/operation, where a more general definition (such as may be found in the description of the corresponding step) may apply for the step/ operation.

Additionally, regarding all of the above, one or more features or operations etc. from any example/embodiment may be combined with features or operations from any other example/embodiment. That is, the disclosure should be considered to include all combinations of examples/embodiments disclosed herein, as appropriate, as well as combinations of individual features within and between each example/embodiment, as appropriate.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement various embodiments of the disclosure. Accordingly, various embodiments provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the disclosure has been shown and described with reference to various embodiments, it will be understood by those skilled in the art that various changes in form and detail may be made therein without departing from the scope of the disclosure.

The reader's attention is directed to all papers and documents which are filed concurrently with or previous to this specification in connection with this application and which are open to public inspection with this specification, and the contents of all such papers and documents are incorporated herein by reference.

### Acronyms and Definitions

3GPP 3rd Generation Partnership Project
5G 5th Generation
5GC 5G Core
5QI 5G QoS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Application Server
ASP Application Service Provider
ATG Air-To-Ground
AUSF Authentication Server Function
CDN Content Delivery Network
DCAF Data Collection Application Function
DNAI Data Network Access Identifier
DNN Data Network Name
DNS Domain Name Server
DRB Data Radio Bearer
eNB Evolved Node B
EPC Evolved Packet Core
FEC Forward Error Correction
FQDN Fully Qualified Domain Name
GBR Guaranteed Bit Rate
gNB Next generation Node B
GPSI Generic Public Subscription Identifier
GW Gateway
HSS Home Subscriber Service
IAB Integrated Access and Backhaul
ID Identity/Identifier
IIoT Industrial Internet of Things
IoT Internet of Things
IMEI International Mobile Equipment Identities
IP Internet Protocol
I-SMF Intermediate SMF
LADN Local Area Data Network
LL SSM Lower Layer SSM
MBMS Multimedia Broadcast/Multicast Service
MBS Multicast/Broadcast Service
MBSF Multicast/Broadcast Service Function
MBSTF Multicast/Broadcast Service Transport Function
MB-SMF Multicast/Broadcast Session Management Function
MB-UPF Multicast/Broadcast User Plane Function
ML Machine Learning
MME Mobility Management Entity
MN Master Node
MNF Monitoring Network Function
MNO Mobile Network Operator
MT Mobile Termination
NAS Non-Access Stratum
NEF Network Exposure Function
NR New Radio
NRF Network Repository Function
NG-RAN Next Generation Radio Access Network
NG-eNB Next Generation eNB
NSA Non-Standalone
NSSF Network Slice Selection Function
NTN Non-Terrestrial Networks
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
PTM Point To Multipoint
PTP Point to Point
QFI QOS Flow Identifier (ID)
QoS Quality of Service
RACH Random Access Channel
RAN Radio Access Network
RRC Radio Resource Control
RSD Route Selection Descriptor
RSRP Reference Signal Received Power
SA Standalone
SDAP Service Data Adaptation Protocol
SDU Service Data Unit
SGW Serving Gateway
SIM Subscriber Identity Module
SLA Service Level Agreement
SM Session Management
SMF Session Management Function
SN Secondary Node
S-NSSAI Single Network Slice Selection Assistance Information
SSB Synchronization Signal Block
SSM Source Specific IP Multicast address
SSC Session and Service Continuity
SRB Signaling Radio Bearer
SUPI Subscription Permanent Identifier
TA Tracking Area
TAI Tracking Area Identity
TE Terminal Equipment
TM Transparent Mode
TMGI Temporary Mobile Group Identity
TS Technical Specification
UAV Unmanned Aerial Vehicle
UDM Unified Data Manager
UDR Unified Data Repository
UE User Equipment
UL Uplink
UM Unacknowledged Mode
UP User Plane
UPF User Plane Function
URLLC Ultra-Reliable and Low-Latency Communication
URSP UE Route Selection Policy

1. A method performed by a user equipment (UE) in a wireless communication system, the method comprising:
assigning a model identifier (ID) to an artificial intelligence (AI) model; and
performing an operation based on the AI model,
wherein the model ID is associated with information on the AI model.

2. The method of claim 1,
wherein the information on the AI model includes information related to a functionality of the AI model.

3. The method of claim 1, further comprising:
transmitting, to a network entity, a first message including capability information on an AI model that the UE supports.

4. The method of claim 1, further comprising:
receiving, from a network entity, a second message for activation or deactivation of the AI model based on the model ID.

5. The method of claim 1,
wherein the information on the AI model further includes information related to data collection of the AI model.

6. The method of claim 1, further comprising:
receiving, from a network entity, a third message including information on a mapping of a model ID and a feature of an AI model.

7. A method performed by a network entity in a wireless communication system, the method comprising:
assigning a model identifier (ID) to an artificial intelligence (AI) model; and
performing an operation based on the AI model,
wherein the model ID is associated with information on the AI model.

8. The method of claim 7,
wherein the information on the AI model includes information related to a functionality of the AI model.

9. The method of claim 7, further comprising:
receiving, from a user equipment (UE), a first message including capability information on AI models that the UE supports.

10. The method of claim 7, further comprising:
transmitting, to a user equipment (UE), a second message for activation or deactivation of the AI model based on the model ID.

11. The method of claim 7, further comprising:
transmitting, to a user equipment (UE), a third message including information on a mapping of a model ID and a feature of an AI model.

12. The method of claim 7,
wherein the information on the AI model further includes information related to data collection of the AI model.

13. A user equipment (UE) in a wireless communication system, the UE comprising:
a transceiver; and
a controller coupled with the transceiver and configured to:
assign a model identifier (ID) to an artificial intelligence (AI) model; and
perform an operation based on the AI model,
wherein the model ID is associated with information on the AI model.

14. The UE of claim 13,
wherein the information on the AI model includes information related to a functionality of the AI model.

15. A network entity in a wireless communication system, the network entity comprising:
a transceiver; and
a controller coupled with the transceiver and configured to:
assign a model identifier (ID) to an artificial intelligence (AI) model; and
perform an operation based on the AI model,
wherein the model ID is associated with information on the AI model.
